(19) United States
(12) Patent Application Publication
(10) Pub. No.: US 2016/0129857 A1
(43) Pub. Date: May 12, 2016

(54) STRUCTURE FOR REDUCING NOISE OF ENGINE ROOM

(71) Applicants: Hyundai Motor Company, Seoul (KR); Kia Motors Corporation, Seoul (KR)

(72) Inventor: Sang Ill LEE, Seoul (KR)

(21) Appl. No.: 14/716,335

(22) Filed: May 19, 2015

(30) Foreign Application Priority Data
Nov. 10, 2014 (KR) 10-2014-0155690

(51) Int. Cl. B60R 13/08; B62D 25/12; B62D 25/08; B62D 25/10

(52) U.S. Cl. CPC B60R 13/0838; B62D 25/105; B62D 25/12; B62D 25/082

(57) ABSTRACT

A structure for reducing noise of an engine room includes a hood configured to open and close an engine room, the hood having opposing inside and outside surfaces, wherein the inside surface is inside the engine room when the hood is closed. A weather strip is disposed on the inside surface of the hood, and sealing rails are configured to be tightly pressed against the weather strip to shield noise generated from the engine room.

### CROSS-REFERENCE TO RELATED APPLICATION

This application is based on and claims the benefit of priority to Korean Patent Application No. 10-2014-0155690, filed on Nov. 10, 2014 in the Korean Intellectual Property Office, the disclosure of which is incorporated herein by reference in its entirety.

### TECHNICAL FIELD

The present disclosure relates to a structure for reducing noise of an engine room and, more particularly, to a structure for reducing noise of an engine room by shielding noise generated by an engine so as to decrease noise of a vehicle.

### BACKGROUND

In general, noise is generated in an engine room of a vehicle as noise is introduced from the outside of a vehicle to the engine room, as well as noise due to actuation of an engine for running a vehicle, actuation of a heating/cooling apparatus, and the like.

In particular, the engine employs operations of sucking, compressing, exploding, and exhausting, generating a considerable amount of noise. The generated noise is transmitted to the interior of a vehicle to degrade riding comfort.

### SUMMARY

The present disclosure has been made to solve the above-mentioned problems occurring in the prior art while advantages achieved by the prior art are maintained intact.

An aspect of of an embodiment of the present inventive concept provides a structure for blocking noise generated in an engine room.

Another aspect of an embodiment of the present inventive concept provides a structure for reducing noise of an engine room that can be easily added to an existing vehicle, increasing utilization.

Technical subjects of the present disclosure are not limited to the foregoing technical subjects and any other technical subjects not mentioned will be clearly understood by a skilled person in the art from the following description.

According to an exemplary embodiment of the present inventive concept, a structure for reducing noise of an engine room includes a hood configured to open and close an engine room, the hood having opposing inside and outside surfaces, wherein the inside surface is inside the engine room when the hood is closed. A weather strip is disposed on the inside surface of the hood. Sealing rails are configured to be tightly pressed against the weather strip to shield noise generated from the engine room.

In certain embodiments, the weather strip may have a substantially triangular shape to surround the engine room. In certain embodiments, the corners of the weather strip may be curved to form chamfers. In certain embodiments, the weather strip may have a substantially trapezoidal shape.

In certain embodiments, the weather strip may have opposing first and second horizontal edges, wherein when the hood is closed, the first horizontal edge is closer to the front of the vehicle and the second horizontal edge is closer to the windshield, and wherein the second horizontal edge is shorter than the first horizontal edge. In certain embodiments, a width of the weather strip may increasingly narrow in a direction from the first horizontal edge to the second horizontal edge.

In certain embodiments, the weather strip may form a single looped curve or a ring.

In certain embodiments, the sealing rails may be disposed on the left and right sides of the engine and may be detachably connected to the engine room.

In certain embodiments, the sealing rails may be sloped such that a distance between the sealing rails and the engine decreases in a direction toward the wind shield from the front of the vehicle.

In certain embodiments, a lower surface of each of the sealing rails may have a curved surface matched in shape to an upper surface of a component disposed in the engine room.

In certain embodiments, an upper surface of each of the sealing rails may have a flat attachment surface so as to be tightly pressed against the weather strip.

In certain embodiments, each of the sealing rails may have a fastening hole configured to fasten the sealing rails to another component within the engine.

In certain embodiments, each of the sealing rails may be fastened by a screw.

In certain embodiments, the structure may further include a partition separating the engine room and a vehicle compartment, and the sealing rails may overlap the partition.

According to another exemplary embodiment of the present inventive concept, a structure for reducing noise of the engine room includes a hood configured to open and close an engine room, the hood having opposing inside and outside surfaces, wherein the inside surface is inside the engine room when the hood is closed. A weather strip may be disposed on the inside surface of the hood and may have a substantially triangular or trapezoidal shape. The weather strip may have left and right sloped surfaces. Sealing rails may be disposed slantingly in the engine room and may be tightly pressed against the left and right sloped surfaces of the weather strip to block noise emitted from the engine room.

Specific matters of other exemplary embodiments are included in the detailed description and drawings.

### BRIEF DESCRIPTION OF THE DRAWINGS

The above and other objects, features and advantages of embodiments of the present inventive concept will be more apparent from the following detailed description taken in conjunction with the accompanying drawings.

FIG. 1 is a view illustrating a disposition of a weather strip according to an exemplary embodiment of the present inventive concept.

FIG. 2 is a view illustrating a state in which the weather strip surrounds the vicinity of an engine room according to an exemplary embodiment of the present inventive concept.

FIG. 3 is a perspective view illustrating a disposition of sealing rails according to an exemplary embodiment of the present inventive concept.

FIG. 4 is a perspective view of the sealing rails according to an exemplary embodiment of the present inventive concept.

FIG. 5 is a cross-sectional view taken along line A-A of FIG. 3, showing a state where the hood is closed over the engine room.

### DETAILED DESCRIPTION

Advantages and features of embodiments of the present inventive concept, and implementation methods thereof will be clarified through following description with reference to the accompanying drawings.

The present inventive concept may, however, be embodied in different forms and should not be construed as limited to the embodiments set forth herein. Further, the present disclosure is only defined by the scope of the claims. Like reference numerals refer to like elements throughout.

Hereinafter, a structure for reducing noise of an engine room 1 according to an exemplary embodiment of the present inventive concept will be described with reference to the accompanying drawings.

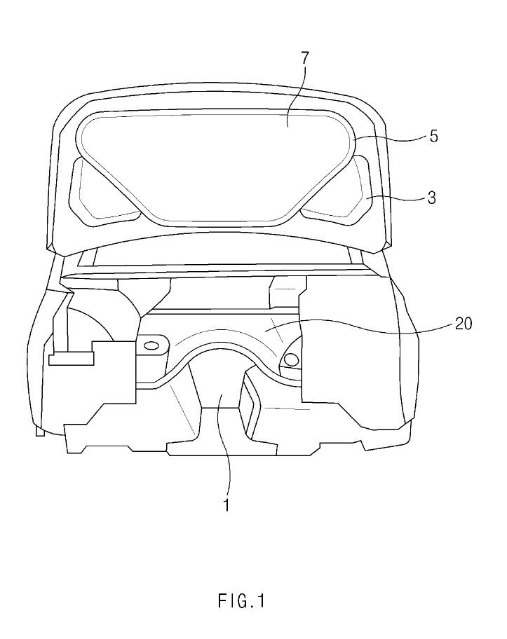

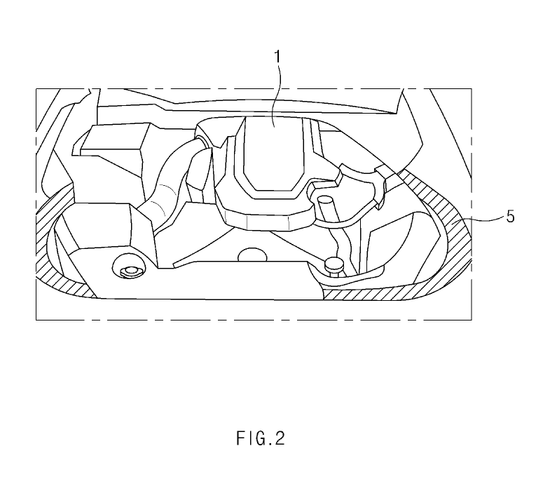

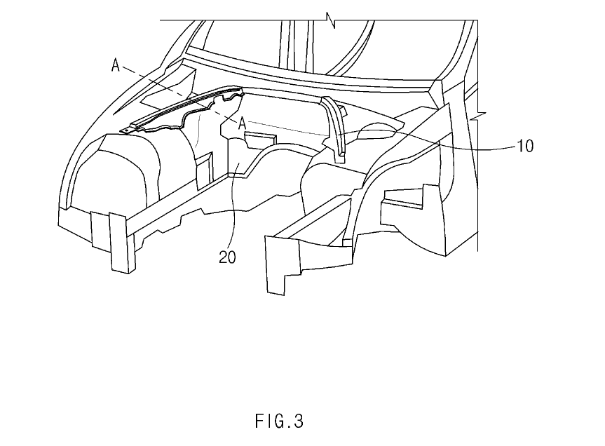

FIG. 1 is a view illustrating a disposition of a weather strip 5 according to an exemplary embodiment of the present inventive concept. FIG. 2 is a view illustrating a state in which the weather strip 5 surrounds an engine room 1 according to an exemplary embodiment of the present inventive concept. FIG. 3 is a perspective view illustrating a disposition of sealing rails 10 according to an exemplary embodiment of the present inventive concept.

Referring to FIGS. 1 through 3, the structure for reducing noise of the engine room 1 according to an exemplary embodiment of the present inventive concept includes a hood 3 for opening and closing the engine room 1, a weather strip 5 disposed on a lower surface of the hood 3 facing the engine room 1, and sealing rails 10 tightly pressed against the weather strip 5 to shield noise generated in the engine room 1. In certain embodiments, the sealing rails 10 are tightly pressed against the weather strip 5 only when the hood 3 is closed over the engine room 1. In certain embodiments, the sealing rails 10 may be attached to the weather strip 5.

In certain embodiments, the weather strip 5 may have a substantially triangular shape. In certain embodiments, the weather strip 5 may have a substantially trapezoidal shape. In certain embodiments, the sealing rails 10 are disposed slantingly in the engine room 1 so as to tightly press against left and right sloped surfaces of the weather strip 5.

An engine is disposed in the engine room 1. The engine room 1 is isolated from the interior of a vehicle, and is isolated from the outside by the hood 3. The engine inevitably accompanies explosion of fuel, generating noise.

In certain embodiments, the hood 3 may be connected to a vehicle body such that the hood 3 pivots in a vertical direction. When closed, the hood 3 covers the engine room 1 to isolate the engine.

In certain embodiments, the corners of the weather strip 5 may be curved to form chamfers 7. In certain embodiments, the weather strip 5 may have a shape in which a horizontal width thereof narrows in a direction toward a wind shield from the front of the vehicle.

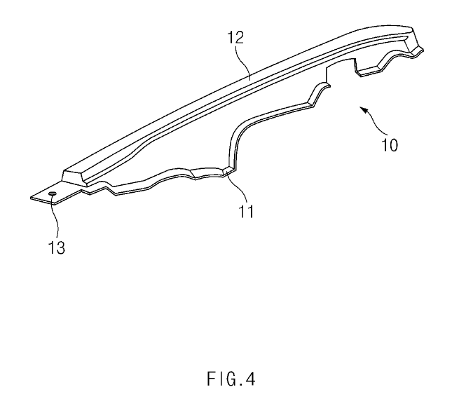

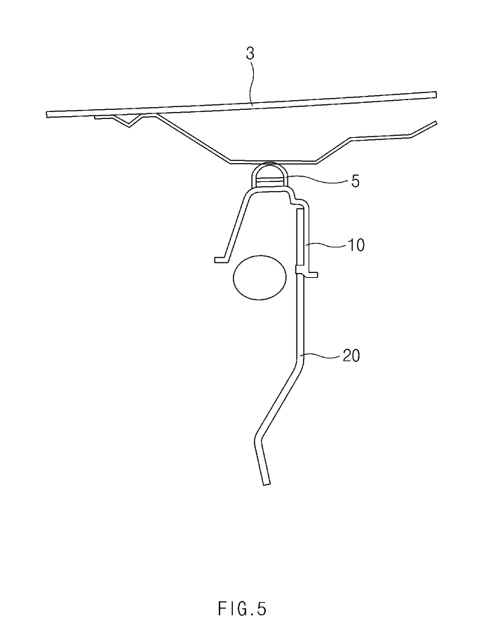

FIG. 4 is a perspective view of the sealing rails 10 according to an exemplary embodiment of the present inventive concept. FIG. 5 is a cross-sectional view taken along line A-A of FIG. 3, showing a state where the hood 3 covers the engine room 1.

Referring to FIGS. 4 and 5, in certain embodiments, the sealing rails 10 are disposed on left and right sides of the engine, and detachably connected to the engine room 1. In certain embodiments, the sealing rails 10 are disposed to be sloped such that a distance between the sealing rails 10 and the engine narrows in a direction toward the wind shield from the front of the vehicle.

A lower surface of each of the sealing rails 10 has a curved surface matched in shape to an upper surface of a component disposed in the engine room 1. An upper surface of each of the sealing rail 10 has a flat attachment surface 12 to be tightly pressed against the weather strip 5. In certain embodiments, each of the sealing rails 10 has a fastening hole 13 fastened to another component within the engine. In certain embodiments, each sealing rail 10 may be fastened with a screw. However, sealing rails 10 may be attached by any other suitable means.

The sealing rails 10 are connected, overlapping a partition 20 separating the engine room 1 and a vehicle compartment. Thus, noise introduced to the vehicle compartment from the engine room 1 is reduced.

A structure for reducing noise of the engine room 1 according to an exemplary embodiment of the present inventive concept may include the hood 3 for opening and closing the engine room 1, the weather strip 5 disposed on a lower surface of the hood 3 facing the engine room 1 and having a substantially triangular or trapezoidal shape, and the sealing rails 10 tightly pressed against the weather strip 5 to block noise emitted from the engine room 1 and disposed slantingly in the engine room 1 so as to be tightly pressed against the left and right sloped surfaces of the weather strip 5.

When the hood 3 covers the engine room 1, the weather strip 5 attached to the hood 3 surrounds the vicinity of the engine room 1. The sealing rails 10 are disposed within the engine room 1. Since the sealing rails 10 need to be tightly pressed against the weather strip 5, the sealing rails 10 may be disposed in a descending position of the weather strip 5. In certain embodiments, the weather strip 5 has a substantially triangular shape centering the engine, and in certain embodiments, the corners thereof are formed to be curved. Thus, in certain embodiments, the weather strip 5 surrounds the engine at a near distance.

In addition to the engine, various components are disposed in the engine room 1, and thus, the components may be connected with each other. Thus, the lower surfaces of the sealing rails 10 may have the curved surface 11 so as to be tightly adjacent various components to surround the vicinity of the engine. Also, the upper surfaces of the sealing rails 10 are formed to be flat and tightly pressed against the weather strip 5. However, according to certain exemplary embodiments, a recess may be formed in the sealing rails 10 such that the weather strip 5 may be inserted thereinto.

In certain embodiments, the weather strip 5 may be formed as a ring. Thus, there is no gap which is inevitably present between end portions. In certain embodiments, the weather strip 5 forms a looped curve without disconnection. Also, the weather strip 5 may increase a degree of airtightness of the vicinity of the engine.

As described above, exemplary embodiments of the present inventive concept have the following advantages.

First, noise generated from the engine room 1 may be blocked.

Second, the structure for reducing noise of an engine room 1 may be easily applied to an existing vehicle, achieving high utilization.

The advantages and effects of the present inventive concept are not limited to the aforesaid, and any other advantages and effects not described herein will be clearly understood by those skilled in the art from descriptions of claims.

The embodiments described above may be variously substituted, altered, and modified by those skilled in the art to which the present inventive concept pertains without departing from the scope and spirit of the present inventive concept. Therefore, the present inventive concept is not limited to the above-mentioned exemplary embodiments and the accompanying drawings.

What is claimed is:

1. A structure for reducing noise of an engine room for an engine, the structure comprising:
a hood configured to open and close an engine room, the hood having opposing inside and outside surfaces, wherein the inside surface is inside the engine room when the hood is closed;
a weather strip disposed on the inside surface of the hood; and
sealing rails configured to be tightly pressed against the weather strip to shield noise generated from the engine room.

2. The structure according to claim 1, wherein the weather strip has a substantially triangular shape to surround the engine room.

3. The structure according to claim 1, wherein the corners of the weather strip are curved to form chamfers.

4. The structure according to claim 1, wherein the weather strip has a substantially trapezoidal shape.

5. The structure according to claim 1, wherein the weather strip has
opposing first and second horizontal edges, wherein when the hood is closed, the first horizontal edge is closer to the front of the vehicle and the second horizontal edge is closer to the windshield, and
wherein the second horizontal edge is shorter than the first horizontal edge.

6. The structure according to claim 5, wherein a width of the weather strip increasingly narrows in a direction from the first horizontal edge to the second horizontal edge.

7. The structure according to claim 1, wherein the weather strip forms a single looped curve or a ring.

8. The structure according to claim 1, wherein the sealing rails are disposed on the left and right sides of the engine and detachably connected to the engine room.

9. The structure according to claim 8, wherein the sealing rails are sloped such that a distance between the sealing rails and the engine decreases in a direction toward the wind shield from the front of the vehicle.

10. The structure according to claim 8, wherein a lower surface of each of the sealing rails has a curved surface matched in shape to an upper surface of a component disposed in the engine room.

11. The structure according to claim 10, wherein an upper surface of each of the sealing rails has a flat attachment surface so as to be tightly pressed against the weather strip.

12. The structure according to claim 10, wherein each of the sealing rails has a fastening hole configured to fasten the sealing rails to another component within the engine.

13. The structure according to claim 12, wherein each of the sealing rails is fastened by a screw.

14. The structure according to claim 10, further comprising a partition separating the engine room and a vehicle compartment, wherein the sealing rails overlap the partition.

15. A structure for reducing noise of an engine room, the structure comprising:
a hood configured to open and close an engine room, the hood having opposing inside and outside surfaces, wherein the inside surface is inside the engine room when the hood is closed;
a weather strip disposed on the inside surface of the hood and having a substantially triangular or trapezoidal shape, the weather strip having left and right sloped surfaces; and
sealing rails disposed slantingly in the engine room and tightly pressed against the left and right sloped surfaces of the weather strip to block noise emitted from the engine room.
